(19) United States
(12) Patent Application Publication
(10) Pub. No.: US 2020/0368866 A1
(43) Pub. Date: Nov. 26, 2020

(54) MACHINE

(71) Applicant: Fanuc Corporation, Yamanashi (JP)

(72) Inventor: Yuuta TOOYAMA, Yamanashi (JP)

(73) Assignee: Fanuc Corporation, Yamanashi (JP)

(21) Appl. No.: 16/821,843

(22) Filed: Mar. 17, 2020

(30) Foreign Application Priority Data
May 22, 2019 (JP) 2019-095911

(51) Int. Cl. B23Q 11/10

(52) U.S. Cl. CPC B23Q 11/10

(57) ABSTRACT

A machine includes a linear drive mechanism, a motor configured to drive the linear drive mechanism, a lubrication agent supply pipe through which a lubrication agent is supplied to the linear drive mechanism, a lubrication agent supply device having a pump and configured to supply the lubrication agent to the linear drive mechanism via the lubrication agent supply pipe, and a controller configured to control the linear drive mechanism, wherein the controller changes a supply interval with which the lubrication agent supply device supplies the lubrication agent to the linear drive mechanism, based on one of a load applied on the linear drive mechanism and an amount of a cutting fluid used by the machine.

### CROSS-REFERENCE TO RELATED APPLICATIONS

This application is based on and claims priority to Japanese Patent Application No. 2019-095911 filed on May 22, 2019, the content of which is incorporated herein by reference in its entirety.

### TECHNICAL FIELD

The present invention relates to a machine.

### BACKGROUND ART

Conventionally, there is known a machine tool including a lubrication agent supply device that supplies a lubrication agent to a linear drive mechanism for moving a table in a horizontal direction, wherein the machine tool is capable of, when a load applied on the table increases, increasing the amount of the lubrication agent supplied from the lubrication agent supply device to the linear drive mechanism. Such a machine tool is disclosed in PTL 1, for example.

### CITATION LIST

### Patent Literature

### {PTL 1}

Japanese Unexamined Patent Application Publication No. 2016-215304

### SUMMARY OF INVENTION

An aspect of the present disclosure relates to a machine includes a linear drive mechanism, a motor configured to drive the linear drive mechanism, a lubrication agent supply pipe through which a lubrication agent is supplied to the linear drive mechanism, a lubrication agent supply device having a pump and configured to supply the lubrication agent to the linear drive mechanism via the lubrication agent supply pipe, and a controller configured to control the linear drive mechanism, wherein the controller changes a supply interval with which the lubrication agent supply device supplies the lubrication agent to the linear drive mechanism, based on one of a load applied on the linear drive mechanism and an amount of a cutting fluid used by the machine.

### BRIEF DESCRIPTION OF DRAWINGS

FIG. 1 is a schematic perspective view of a machine tool according to a first embodiment of the present invention.

FIG. 2 is a back view of an X-Y table of the machine tool according to the first embodiment.

FIG. 3 is a schematic side view of the machine tool according to the first embodiment.

FIG. 4 is a block diagram of a controller of the machine tool according to the first embodiment.

FIG. 5 is a flowchart of an example of a process of the controller of the machine tool according to the first embodiment.

FIG. 6 is an example of a table for associating motor torque with set time periods according to the first embodiment.

FIG. 7 is a flowchart of an example of a process of a controller of a machine tool according to a second embodiment.

FIG. 8 is an example of a table for associating amounts of supply of a cutting fluid with set distances according to the second embodiment.

### DESCRIPTION OF EMBODIMENTS

Hereinafter, a machine according to a first embodiment will be described with reference to the drawings.

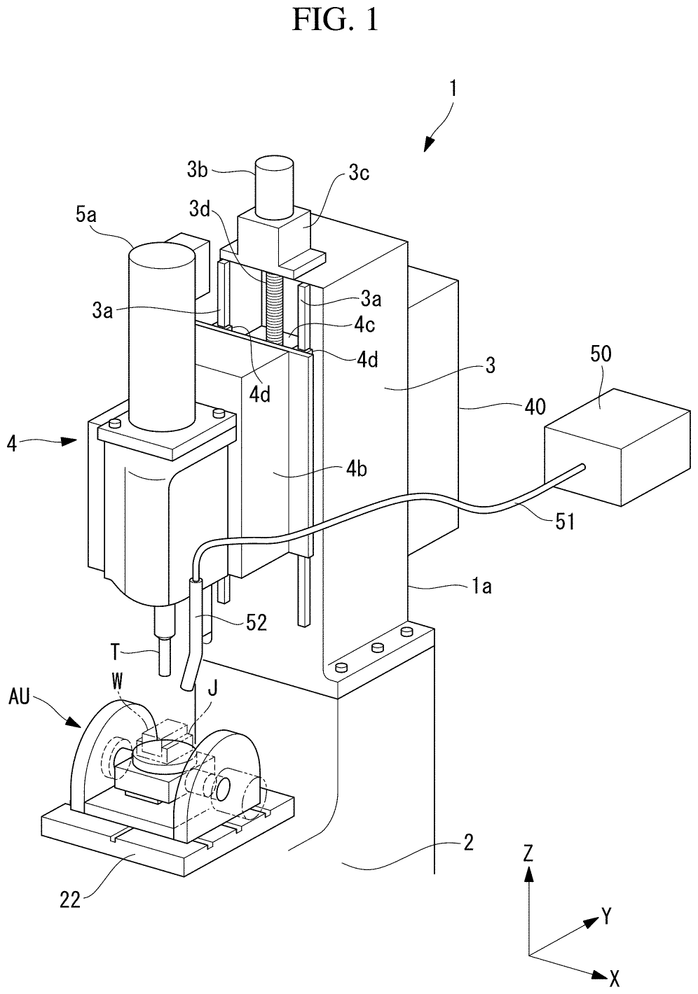

An example of the machine according to this embodiment is a machine tool. As shown in FIG. 1, this machine tool includes: a machine tool main body 1a having a base 2 and a column portion 3 extending upward from the base 2; a spindle unit 4 supported on the column portion 3 so as to be vertically movable; and an X-Y table 22 that supports a workpiece W. The machine tool according to this embodiment is placed within a machining room not shown in the drawings.

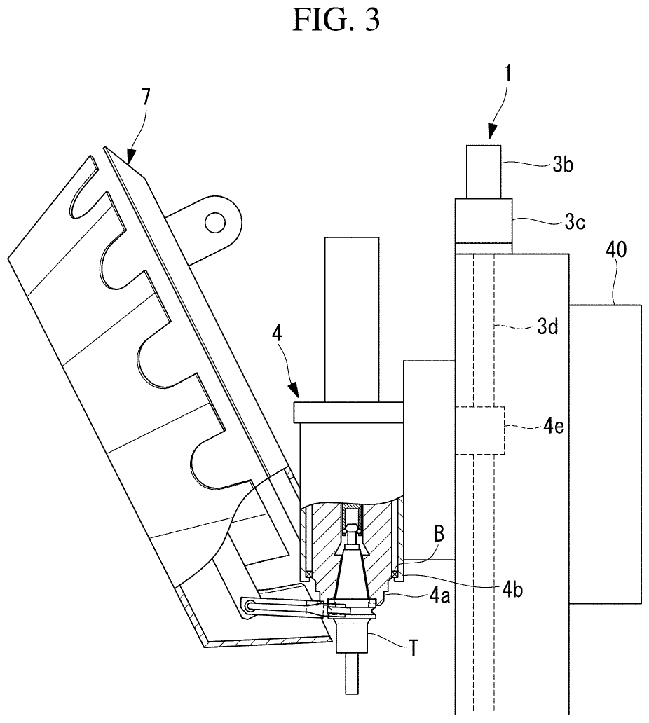

As shown in FIG. 3, the machine tool according to this embodiment includes a tool magazine 7 for automatically changing a tool T attached to a spindle 4a of the spindle unit 4. One of a plurality of tools T contained in the tool magazine 7 is selectively held by the spindle 4a. The spindle unit 4 includes a spindle head 4b that supports the spindle 4a via a plurality of bearings B.

The column portion 3 is provided with a plurality of guide rails 3a extending in a vertical direction (Z-axis direction), and the spindle head 4b is supported by the guide rails 3a via sliders 4d so as to be movable in the vertical direction. Further, a Z-axis motor 3b such as a servo motor is fixed to the upper end of the column portion 3, and an output from an output shaft of the Z-axis motor 3b is transmitted to a ball screw 3d via a reducer 3c and the like. The ball screw 3d is disposed along the guide rails 3a, and threaded with a ball screw nut 4e fixed to a back surface 4c of the spindle head 4b. In this manner, the spindle head 4b is able to move vertically by a linear drive mechanism.

Further, the spindle 4a and the tool T rotate about the central axial line of the spindle 4a by a spindle motor 5a connected to an upper end of the spindle 4a.

The machine tool relatively moves the workpiece W and the tool T by horizontal movement of the X-Y table 22, vertical movement of the spindle 4a, and the like, and thus performs machining to the workpiece W by the rotating tool T.

The base 2 is installed using a leveling bolt, an anchor bolt, or the like, for example, at a place where the machine tool is used. The X-Y table 22 is positioned on the base 2, and the workpiece W is fixed on an upper surface of the X-Y table 22 via a jig J, an additional axial unit AU, or the like. The X-Y table 22 and the workpiece W are moved in a horizontal direction with respect to the spindle 4a by motors 13 and 23 attached to the base 2.

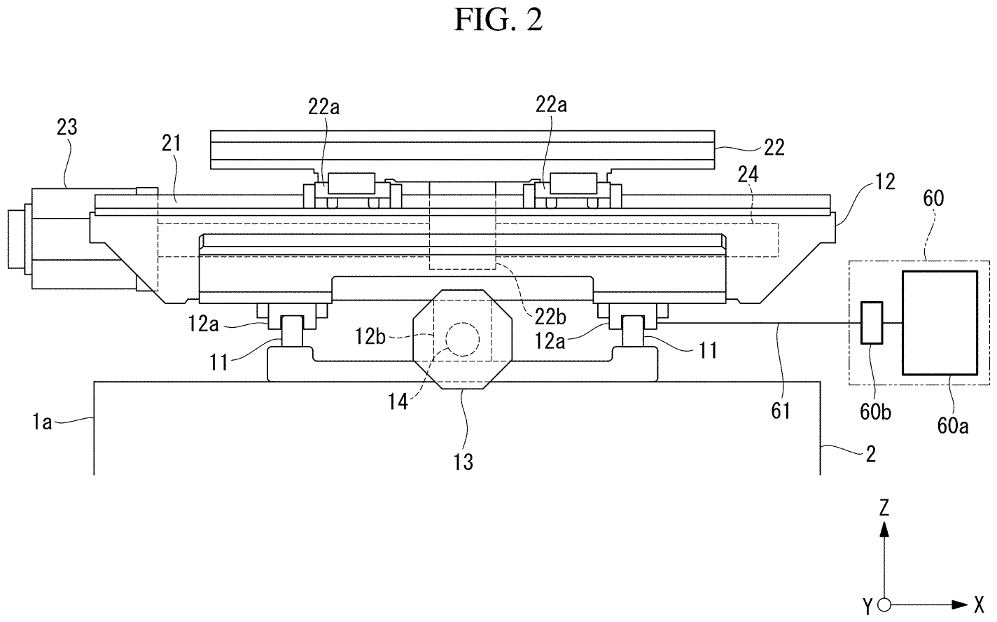

As shown in FIG. 2, an upper surface portion of the base 2 is provided with a plurality of guide rails 11 extending in a Y-axis direction which is the horizontal direction, and a Y-directional movable portion 12 is supported by the guide rails 11 via sliders 12a so as to be movable in the Y-axis direction. Further, a Y-axis motor 13 is fixed to the upper end of the base 2, and an output from the Y-axis motor 13 is transmitted to a ball screw 14 via a reducer and the like. The ball screw 14 is disposed along the guide rails 11, and threaded with a ball screw nut 12b which is fixed to the Y-directional movable portion 12. In this manner, the linear drive mechanism in which the Y-directional movable portion 12 moves in the Y-axis direction by the rotation of the output shaft of the Y-axis motor 13 is configured.

Further, as shown in FIG. 2, the upper surface portion of the Y-direction movable portion 12 is provided with a plurality of guide rails 21 extending in an X-axis direction which is the horizontal direction, and the X-Y table 22 is supported by the guide rails 21 via sliders 22a so as to be movable in the X-axis direction. Moreover, an X-axis motor 23 is fixed to the upper surface portion of the Y-direction movable portion 12, and an output from an output shaft of the X-axis motor 23 is transmitted to a ball screw 24 via a reducer and the like. The ball screw 24 is arranged along the guide rails 21, and threaded with a ball screw nut 22b which is fixed to the X-Y table 22. In this manner, the linear drive mechanism in which the X-Y table 22 moves in the X-axis direction by the rotation of the output shaft of the X-axis motor 23 is configured.

Within the machining room, a cutting fluid nozzle 52 for spraying a cutting fluid to the tool T or the workpiece W is provided. In this embodiment, the cutting fluid nozzle 52 is attached to the spindle head 4b. The cutting fluid nozzle 52 is connected to a cutting fluid supply device 50 via a cutting fluid supply pipe 51, and the cutting fluid is supplied from the cutting fluid supply device 50 to the cutting fluid nozzle 52. The cutting fluid supply device 50 is provided with a pump, a valve, and the like for feeding the cutting fluid to the cutting fluid nozzle 52, and is controlled by a controller 40 described later.

One end of a lubrication agent supply pipe 61 is connected to each of the sliders 4d, 12a, and 22a and the ball screw nuts 4e, 12b, and 22b of the linear drive mechanism. While FIG. 2 shows that the lubrication agent supply pipe 61 is connected to only one of the sliders 12a, the lubrication agent supply pipe 61 is connected to the other slider 12a, and the other sliders 4d and 22a, as well as to the ball screw nuts 4e, 12b, and 22b. Here, a lubrication agent supplied to the one slider 12a may be supplied to the other slider 12a, and the other sliders 4d and 22a, as well as to the ball screw nuts 4e, 12b, and 22b through a distribution pipe, a distribution supply channel, or the like that is not shown in the drawings.

The other end of the lubrication agent supply pipe 61 is connected to a lubrication agent supply device 60. The lubrication agent supply device 60 includes: a pump 60a, and a known continuous flow valve 60b disposed between the pump 60a and the other end of the lubrication agent supply pipe 61. The continuous flow valve 60b according to this embodiment includes a solenoid valve, an air cylinder with a valve, or the like. When a pilot plunger is moved to one direction by the solenoid valve, the air cylinder, or the like, the continuous flow valve 60b is turned to an opened state, and a lubrication agent of a certain amount contained within the continuous flow valve 60b is supplied from the continuous flow valve 60b to the sliders 12a via the lubrication agent supply pipe 61.

The continuous flow valve 60b supplies a lubrication agent only contained therein to the sliders 12a, and may not supply any further. When the pilot plunger is moved to the other direction by the solenoid valve, the air cylinder, or the like, the continuous flow valve 60b is turned to a closed state, and the lubrication agent is not supplied from the continuous flow valve 60b. Further, in the closed state, the lubrication agent is reserved within the continuous flow valve 60b by the pump 60a. The lubrication agent supply device 60 is controlled by the controller 40 that will be later described. Examples of the lubrication agent include a known grease and a known oil.

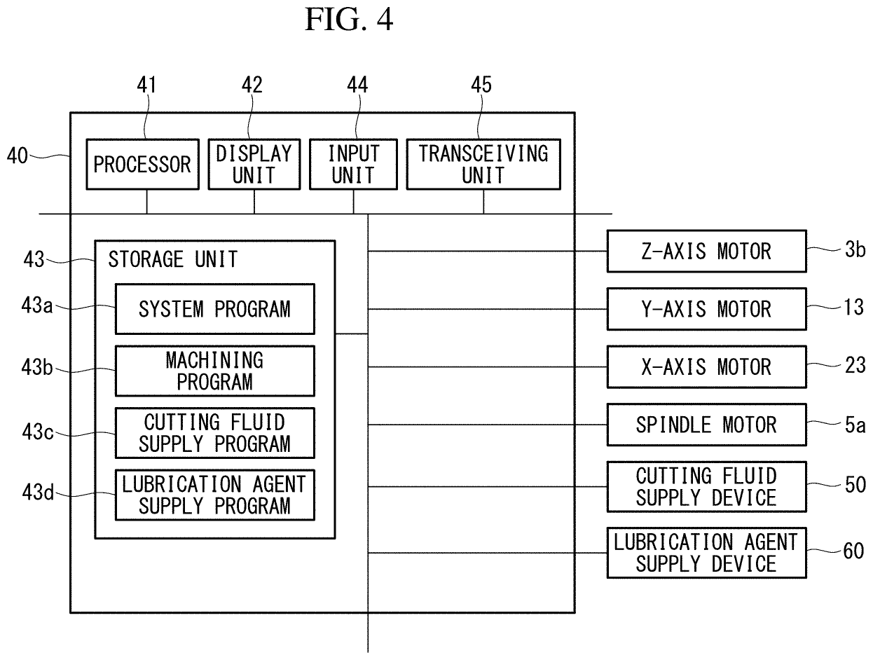

The machine tool is provided with the controller 40 that controls the machine tool. As shown in FIG. 4, the controller 40 includes: a processor 41 such as a CPU; a display unit 42; a storage unit 43 having a nonvolatile storage, a ROM, and the like; an input unit 44 such as an operation panel; and a transceiving unit 45 having an antenna, a connector, and the like. The storage unit 43 stores a system program 43a, which carries out a basic function of the controller 40.

Further, the storage unit 43 stores a machining program 43b, a cutting fluid supply program 43c, and a lubrication agent supply program 43d. The controller 40 transmits control commands to the motors 3b, 13, and 23, the cutting fluid supply device 50, and the like based on the machining program 43b and the cutting fluid supply program 43c, and with this, machining by the machine tool, exchange of the tool T of the spindle 4a using the tool magazine 7, and the like are carried out. The cutting fluid supply program 43c and the lubrication agent supply program 43d may be a part of the machining program 43b.

The controller 40 turns the continuous flow valve 60b of the lubrication agent supply device 60 to the opened state with a set supply interval based on the lubrication agent supply program 43d. The supply interval may be a time period (set time period) from supply of the lubrication agent to next supply of the lubrication agent, or a distance (set distance) by which the sliders 12a as the linear drive mechanism move during the period from the supply of the lubrication agent supply to the next supply of the lubrication agent. In this embodiment, the controller 40 turns the continuous flow valve 60b to the opened state after, for example, 10 minutes as the set time period elapses after previous supply of the lubrication agent.

When the controller 40 turns the continuous flow valve 60b to the opened state, the lubrication agent of a predetermined amount filled within the continuous flow valve 60b is supplied to the sliders 12a. With this, the lubrication agent of a predetermined amount is supplied to the sliders 12a every set time period.

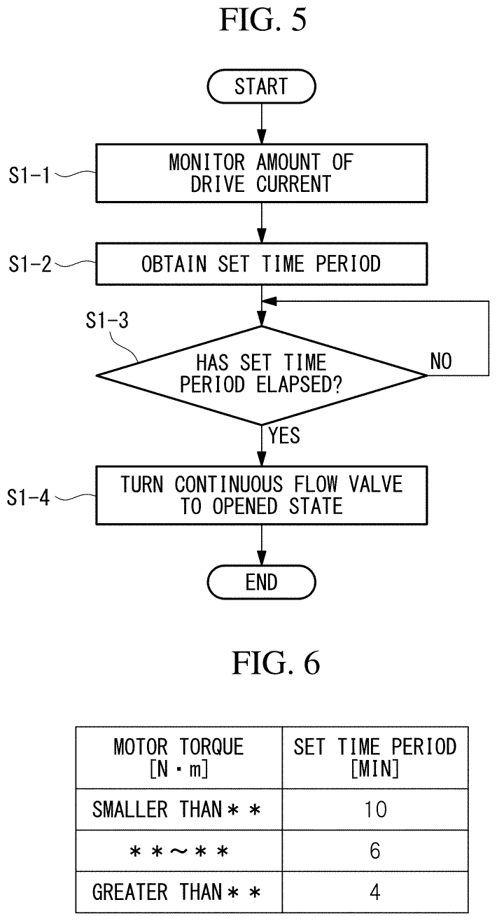

The controller 40 changes the supply interval based on the lubrication agent supply program 43d, according to a change in a load applied to the sliders 12a. A process by the controller 40 at this time is described with reference to a flowchart shown in FIG. 5. While the set time period is changed as one example of the supply interval in this embodiment, it is possible to change the set distance.

The controller 40 monitors an amount of drive current of the Y-axis motor 13 (Step S1-1), sequentially calculates motor torque of the Y-axis motor 13 based on the monitored amount of drive current, and obtains a set time period corresponding to the calculated motor torque (Step S1-2). For example, as shown in FIG. 6, the storage unit 43 of the controller 40 stores a table in which motor torque and set time periods are associated with each other. In this case, in Step S1-2, the controller 40 refers to the table, and thereby obtains a set time period corresponding to the calculated motor torque. Here, a value determined by a user is applied in “*” in the table.

It should be noted that in Step S1-2, the set time period may be obtained based on the amount of drive current of the Y-axis motor 13. In this case, in the table shown in FIG. 6, amounts of drive current and set time periods are associated with each other. Further, in Step S1-2, instead of this table, an expression for obtaining a set time period from motor torque or an amount of drive current may be used.

As one example, the amount of drive current or the motor torque applied to this table or the expression in Step S1-2 is a maximum amount of drive current or maximum motor torque during a predetermined past period of time. This amount of drive current or the motor torque may be a maximum amount of drive current or maximum motor torque occurred during one cycle of the machining program 43b that is carried out immediately before. This amount of drive current or the motor torque may be an average value of amounts of drive current or motor torque during a predetermined past period of time, or may be a different value relating to the amount of drive current or the motor torque.

When the obtained set time period elapses (Step S1-3), the controller 40 turns the continuous flow valve 60b to the opened state for a predetermined length of time (Step S1-4). The continuous flow valve 60b is turned to the opened state for the predetermined length of time for a control reason, which is not a reason for controlling an amount of supply of the lubrication agent from the continuous flow valve 60b.

Here, as the pump 60a is always in a driven state in this embodiment, the controller 40 controls only the continuous flow valve 60b every set time period. If the pump 60a is not always in a driven state, the controller 40 drives the pump 60a according to an operation of the continuous flow valve 60b.

In this embodiment, the machine tool includes: the motors 3b, 13, and 23 for driving the linear drive mechanism; the sliders 4d, 12a, and 22a and the ball screw nuts 4e, 12b, and 22b as linear drive units that are driven by the motors 3b, 13, and 23. Further, the machine tool includes the lubrication agent supply pipe 61 for supplying the lubrication agent to the sliders 4d, 12a, and 22a and the ball screw nuts 4e, 12b, and 22b as the linear drive units of the linear drive mechanism. Moreover, the machine tool includes the pump 60a, and is provided with the lubrication agent supply device 60 that supplies the lubrication agent to the sliders 4d, 12a, and 22a, and the ball screw nuts 4e, 12b, and 22b as the linear drive units via the lubrication agent supply pipe 61.

Further, the controller 40 changes the supply interval with which the lubrication agent supply device 60 supplies the lubrication agent to the linear drive mechanism, according to the load applied on the linear drive mechanism. In this embodiment, as the amount of drive current of the motors 3b, 13, and 23 varies according to the load applied on the linear drive mechanism, the supply interval is changed based on the amount of drive current of the motors 3b, 13, and 23.

Accordingly, for example, as a weight of the jig J or the like loaded on the X-Y table 22 of the machine tool increases, the supply interval of the lubrication agent to the sliders 4d, 12a, and 22a and the ball screw nuts 4e, 12b, and 22b becomes shorter. Alternatively, as the load applied on the X-Y table 22 during machining increases, the supply interval of the lubrication agent to the sliders 4d, 12a, and 22a and the ball screw nuts 4e, 12b, and 22b becomes shorter.

When the load on the sliders 4d, 12a, and 22a and the ball screw nuts 4e, 12b, and 22b increases, a lubrication agent film for these components tends to be insufficient. However, according to this embodiment, it is possible to prevent the lubrication agent film from becoming insufficient when the load increases.

Further, in this embodiment, the supply interval is changed according to the amount of drive current of the motors 3b, 13, and 23. Therefore, it is not necessary to provide a dedicated sensor for ensuring the film of the lubrication agent, as well as to change the continuous flow valve 60b.

It should be noted that it is possible to provide a sensor for detecting the load applied on the X-Y table 22, a sensor for detecting the load applied on the sliders 4d, 12a, and 22a, and the like. For example, a force sensor for detecting the load applied on the sliders 12a may be provided for the sliders 12a. In this case, a value detected by the force sensor is monitored in Step S1-1, and a set time period corresponding to the value detected by the force sensor is obtained in Step S1-2.

Hereinafter, a machine according to a second embodiment will be described with reference to the drawings.

The machine according to the second embodiment is a machine tool that is the same as the machine tool of the first embodiment shown in FIG. 1. Like components as those in the first embodiment are denoted by same reference numerals, and these components are not described.

The second embodiment is to change a supply interval of a lubrication agent according to an amount of a cutting fluid used by the machine tool. More specifically, the supply interval of the lubrication agent is changed according to the amount of the cutting fluid supplied to the workpiece W which is an object supported by the sliders 4d, 12a, and 22a and moved by the ball screw nuts 4e, 12b, and 22b.

In the second embodiment, the continuous flow valve 60b of the lubrication agent supply device 60 is turned to the opened state with a set supply interval based on the lubrication agent supply program 43d. In the second embodiment, the controller 40 turns the continuous flow valve 60b to the opened state after the sliders 12a move by, for example, 10 meters as a set distance after the supply of the lubrication agent.

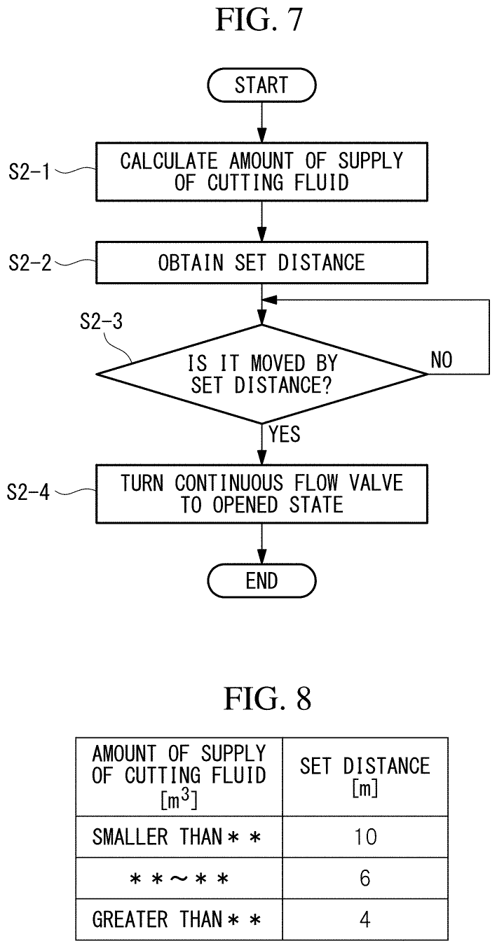

The controller 40 changes the supply interval based on the lubrication agent supply program 43d, according to an amount of the cutting fluid supplied from the cutting fluid supply device 50 to the cutting fluid nozzle 52. A process performed by the controller 40 at this time is described with reference to a flowchart shown in FIG. 7. While the set distance is changed as one example of the supply interval in the second embodiment, but the set time period may be changed.

The controller 40 calculates an amount of supply of the cutting fluid within one cycle or a predetermined length of time based on the cutting fluid supply program 43c (Step S2-1), and obtains a set distance corresponding to the calculated amount of supply of the cutting fluid (Step S2-2). The cutting fluid supply program 43c is one example of information regarding an operational state of the cutting fluid supply device 50. For example, as shown in FIG. 8, the storage unit 43 of the controller 40 stores a table in which amounts of supply of the cutting fluid and set distances are associated with each other. In this case, in Step S2-2, the controller 40 refers to the table, and thereby obtains a set distance corresponding to the calculated amount of supply of the cutting fluid.

Here, a value determined by the user, or a value determined based on the past data or the like is applied in “*” in the table. Further, in Step S2-2, instead of this table, an expression for obtaining a set distance from an amount of supply of the cutting fluid may be used. Moreover, a result of detection by a flow sensor provided for the cutting fluid supply device 50, the cutting fluid nozzle 52, or the like may be monitored in Step S2-1, and a set distance corresponding to the detected flow may be obtained in Step S2-2. The result of detection by the flow sensor is a different example of the operational state of the cutting fluid supply device 50.

When the sliders 12a move by the set distance after previous supply of the lubrication agent (Step S2-3), the controller 40 turns the continuous flow valve 60b to the opened state for a predetermined length of time (Step S2-4). It should be noted that the pump 60a also is always in a driven state in the second embodiment, and the controller 40 controls only the continuous flow valve 60b every set time period.

In the second embodiment, the machine tool includes: the motors 3b, 13, and 23 for driving the linear drive mechanism; the sliders 4d, 12a, and 22a and the ball screw nuts 4e, 12b, and 22b as linear drive units that are driven by the motors 3b, 13, and 23. Further, the machine tool includes the lubrication agent supply pipe 61 for supplying the lubrication agent to the sliders 4d, 12a, and 22a and the ball screw nuts 4e, 12b, and 22b as the linear drive units of the linear drive mechanism. Moreover, the machine tool includes the pump 60a, and is provided with the lubrication agent supply device 60 that supplies the lubrication agent to the sliders 4d, 12a, and 22a, and the ball screw nuts 4e, 12b, and 22b as the linear drive units via the lubrication agent supply pipe 61.

Further, the controller 40 changes the supply interval with which the lubrication agent supply device 60 supplies the lubrication agent to the linear drive mechanism, according to the amount of the cutting fluid supplied to the machine tool. Accordingly, for example, as the amount of the cutting fluid supplied to the machine tool increases, the supply interval of the lubrication agent to the sliders 4d, 12a, and 22a and the ball screw nuts 4e, 12b, and 22b becomes shorter. When the amount of the cutting fluid sprayed to the sliders 4d, 12a, and 22a and the ball screw nuts 4e, 12b, and 22b increases, the lubrication agent film for these components tends to become insufficient. However, according to the second embodiment, it is possible to prevent the lubrication agent film from becoming insufficient when the amount of the cutting fluid increases.

Further, in the second embodiment, the supply interval is changed according to information of the amount of supply of the cutting fluid obtained from the cutting fluid supply program 43c that shows the operational state of the cutting fluid supply device 50. Therefore, it is not necessary to provide a dedicated sensor for ensuring the lubrication agent film, as well as to change the continuous flow valve 60b.

It should be noted that in the first embodiment, it is possible to record a value of the load input by a user of the machine tool in the storage unit 43, and to obtain a set time period corresponding to the recorded value of the load in Step S1-2. In this case, it is also not necessary to provide a dedicated sensor for securing the lubrication agent film, as well as to change the continuous flow valve 60b.

It should be noted that the above configuration according to each of the above embodiments may be employed for a machine having a robot and a linear drive device on which the robot is mounted. In this case, the linear drive device includes: rails; sliders movably supported by the rails; a ball screw and a ball screw nut for moving the slider; and a motor for rotating the ball screw. Further, the lubrication agent supply device 60 is connected to the sliders via the lubrication agent supply pipe 61. In this case, the supply interval of the lubrication agent may also be changed by the controller according to the load applied on the slider.

It should be noted that in the above embodiments, when a large force in the Y-axis direction is applied, for example, on the sliders 12a and the ball screw nut 12b of the linear drive mechanism in a state in which the Y-axis motor 13 is stopped, for example, this force may be estimated based on an amount of current of the Y-axis motor 13. Thus, it is possible to set a supply interval according to the estimated force.

### REFERENCE SIGNS LIST

2 Base
3 Column portion
3a Guide rail
3b Z-axis motor
3d Ball screw
4 Spindle unit
4a Spindle
4b Spindle head
4e Ball screw nut
7 Tool magazine
11 Guide rail
12 Y-directional movable portion
12a Slider
12b Ball screw nut
13 Y-axis motor
14 Ball screw
21 Guide rail
22 X-Y table
22a Slider
22b Ball screw nut
23 X-axis motor
24 Ball screw
40 Controller
43 Storage unit
43a System program
43b Machining program
43c Cutting fluid supply program
43d Lubrication agent supply program
50 Cutting fluid supply device
52 Cutting fluid nozzle
60 Lubrication agent supply device
60a Pump
60b Continuous flow valve
61 Lubrication agent supply pipe
T Tool
B Bearing
J Jig
W Workpiece

1. A machine comprising:
a linear drive mechanism;
a motor configured to drive the linear drive mechanism;
a lubrication agent supply pipe through which a lubrication agent is supplied to the linear drive mechanism;
a lubrication agent supply device having a pump and configured to supply the lubrication agent to the linear drive mechanism via the lubrication agent supply pipe; and
a controller configured to control the linear drive mechanism, wherein
the controller changes a supply interval with which the lubrication agent supply device supplies the lubrication agent to the linear drive mechanism, based on one of a load applied on the linear drive mechanism and an amount of a cutting fluid used by the machine.

2. The machine according to claim 1, wherein
the controller changes the supply interval based on an amount of current of the motor that varies according to the load.

3. The machine according to claim 1, wherein
the controller obtains information of an operational state of a cutting fluid supply device configured to supply the cutting fluid, and changes the supply interval according to the information of the operational state.
